(19) United States
(12) Patent Application Publication
(10) Pub. No.: US 2012/0297682 A1
(43) Pub. Date: Nov. 29, 2012

(54) WINDOW REGULATOR OF VEHICLE

(75) Inventor: Chang Gi Ha, Hwaseong-si (KR)

(73) Assignee: Hyundai Motor Company, Seoul (KR)

(21) Appl. No.: 13/303,721

(22) Filed: Nov. 23, 2011

(30) Foreign Application Priority Data
May 26, 2011 (KR) 10-2011-0049877

(51) Int. Cl. B60J 1/17; B23P 17/04

(52) U.S. Cl. 49/358; 29/428

(57) ABSTRACT

A window regulator assembly of a vehicle may include an actuator, a wire connected to the actuator and actuated by the actuator, an upper pulley and a lower pulley provided in upper and lower positions of a door for guiding movement of the wire, a pulley locking unit provided for mounting the upper pulley and the lower pulley to the door, and a removable support member, wherein the removable support member controls a relative position of the upper pulley and the lower pulley therebetween and may be removed from the upper pulley and the lower pulley after the upper pulley and the lower pulley may be installed on the door.

### CROSS-REFERENCE TO RELATED APPLICATIONS

The present application claims priority to Korean Patent Application No. 10-2011-0049877 filed on May 26, 2011, the entire contents of which is incorporated herein for purposes by this reference.

### BACKGROUND OF THE INVENTION

1. Field of the Invention

The present invention relates, in general, to a window regulator of a vehicle and, more particularly, to a window regulator which has a simple structure able to reduce the weight and production cost of the window regulator.

2. Description of Related Art

A window regulator of a vehicle is a device that a user uses to move a window pane of a door upwards or downwards. In the related art, various types of window regulators have been proposed and used. An example of a simple window regulator is one having a guide rail, as shown in FIG. 1.

The window regulator 500 shown in FIG. 1 includes a carrier plate 502, which carries a window pane and moves upwards and downwards along with the window pane, a guide rail, which guides movement of the carrier plate 502, and an actuator 506 which is connected to the carrier plate 502 by a wire 504 so as to supply power to the carrier plate 502. The guide rail is provided with an upper pulley 508 and a lower pulley 510 in upper and lower ends thereof and guides movement of the wire 504. The guide rail is mounted to an inner door panel using mounting brackets 512.

The conventional window regulator 500 having the above-mentioned construction is operated in such a way that, when the wire 504 is moved along the guide rail upwards and downwards by the actuator 506, the carrier plate 502 mounted to the wire 504 is moved along the guide rail upwards and downwards by the wire 504, thus moving the window pane upwards and downwards.

The information included in this Background of the Invention section may be only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a window regulator of a vehicle, which has a simple structure compared to a conventional window regulator, so that it has a reduced number of parts and reduced weight, thereby reducing the production cost of the vehicle and improving the fuel mileage of the vehicle.

In an aspect of the present invention, a window regulator assembly of a vehicle, may include an actuator, a wire connected to the actuator and actuated by the actuator, an upper pulley and a lower pulley provided in upper and lower positions of a door for guiding movement of the wire, a pulley locking unit provided for mounting the upper pulley and the lower pulley to the door, and a removable support member, wherein the removable support member controls a relative position of the upper pulley and the lower pulley therebetween and may be removed from the upper pulley and the lower pulley after the upper pulley and the lower pulley may be installed on the door.

The pulley locking unit may include a pulley bracket provided for rotatably supporting a rotating shaft of the upper and lower pulleys respectively thereto, and a bracket locking unit provided for mounting the pulley bracket to the door, wherein the removable support member may be coupled to the bracket locking unit and released therefrom after the upper pulley and the lower pulley may be installed on the door.

The bracket locking unit may include a locking part mounting the pulley bracket to the door, and a support holding part integrally extending from the locking part and removably holding the removable support member thereto.

The locking part may include a pressure flange biasing the pulley bracket to the door under pressure, and a threaded part extending from the pressure flange and passing through a door inner panel of the door, and being tightened to a locking nut, and wherein the support holding part may include a support rod extending from the pressure flange to which the removable support member may be removably engaged, and a guide flange formed on an end of the support rod to retain the removable support member between the pressure flange and the guide flange.

The removable support member may be constructed in such a way that the removable support member controls the relative position of the upper pulley and the lower pulley and after construction thereof to the bracket locking unit may be removed from the bracket locking unit in response to a pressure causing a displacement of the removable support member relative to the pulley locking unit.

The removable support member may include an elastic support part formed to open in one direction to receive a support rod of the bracket locking unit, wherein the elastic support part may be deformed and released from the support rod in response to a pressure, which may be applied to the elastic support part in an opposite direction of the one direction.

An end of the elastic support part may include an arc-shaped locking groove to receive the support rod therein.

The elastic support part of the removable support member may include a plurality of elastic support parts which may have the same orientation in such a way that the elastic support parts may be deformed by pressure so as to move the removable support member in the opposite direction of the one direction and thus to release the removable support member from the support rod.

The elastic support part of the removable support member may be formed by bending an end of the removable support member inwards to open in the one direction such that the elastic support part elastically compresses the support rod of the pulley locking unit inside the removable support member.

In another aspect of the present invention, a method of a window regulator assembly of a vehicle, may include installing a pulley bracket having an upper pulley and a lower pulley on a door by using a removable support member wherein the removable support member temporarily controls a relative position of the upper pulley and the lower pulley, and removing the removable support member from the door after construction of the pulley bracket.

As described above, the window regulator of the vehicle according to is advantageous in that it has a simple structure compared to a conventional window regulator, thus reducing the number of parts and the weight, thereby reducing the production cost of the vehicle and improving the fuel mileage of the vehicle.

The methods and apparatuses of the present invention have other features and advantages which will be apparent from or may be set forth in more detail in the accompanying drawings, which may be incorporated herein, and the following Detailed Description, which together serve to explain certain principles of the present invention.

### BRIEF DESCRIPTION OF THE DRAWINGS

FIG. 1 is a view of a conventional window regulator of a vehicle.

FIG. 2 is a view of a window regulator of a vehicle according to an exemplary embodiment of the present invention.

FIG. 3 is a partially sectioned view showing an installed structure of the window regulator of a vehicle according to an exemplary embodiment of the present invention.

FIG. 4 is a view showing an exemplary embodiment of a bracket locking unit of FIG. 3.

FIG. 5 is a sectional view taken along line V-V of FIG. 3.

FIG. 6 is a view showing the separation of a removable support member from the window regulator of the vehicle according to an exemplary embodiment of the present invention.

FIG. 7 is a view showing a state in which the window regulator of the present invention has been completely installed in a vehicle.

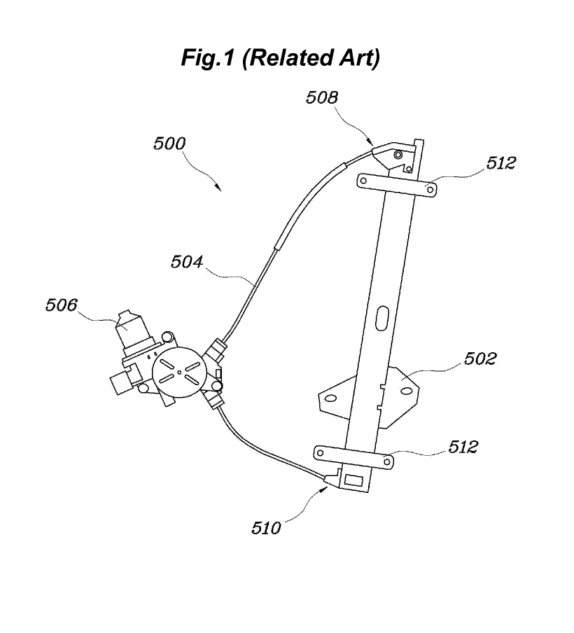

It should be understood that the appended drawings may be not necessarily to scale, presenting a somewhat simplified representation of various features illustrative of the basic principles of the invention. The specific design features of the present invention as included herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of (s), examples of which may be illustrated in the accompanying drawings and described below. While the invention(s) will be described in conjunction with exemplary embodiments, it will be understood that the present description may be not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference will now be made in greater detail to a preferred embodiment of the invention with reference to the accompanying drawings.

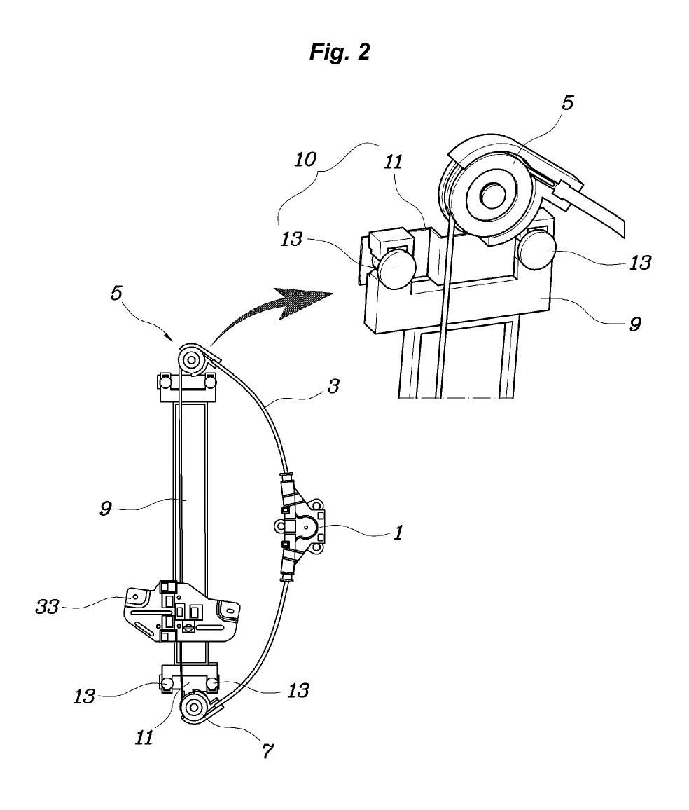

As shown in FIG. 2 through FIG. 5, a window regulator of a vehicle according to an exemplary embodiment of the present invention includes an actuator 1, a wire 3 connected to the actuator 1 so as to be actuated thereby, an upper pulley 5 and a lower pulley 7 provided in upper and lower positions for guiding movement of the wire 3, a pulley locking unit 10 provided for locking the upper pulley 5 and the lower pulley 7 to the door, and a removable support member 9 provided in such a way that the removable support member 9 can be removed from both the upper pulley 5 and the lower pulley 7 and can control the relative position of the upper pulley 5 and the lower pulley 7.

The window regulator of the present invention is assembled in a door of a vehicle as shown in FIG. 2. After the upper pulley 5 and the lower pulley 7 are installed in respective locations, the removable support member 9 is removed from both the upper pulley 5 and the lower pulley 7, thus realizing an advantage in that a part corresponding to a conventional guide rail can be removed from a vehicle body.

The pulley locking unit 10 includes pulley brackets 11 which rotatably hold the rotating shafts of respective pulleys 5 and 7 on the door, and bracket locking units 13 which mount respective pulley brackets 11 to the door.

Each of the pulley brackets 11 includes a shaft mounting part, to which the rotating shaft of an associated pulley is mounted, and a door mounting part on which the pulley bracket 11 is mounted to a surface of the door. The door mounting part of the pulley bracket 11 is mounted to the door using the bracket locking unit 13. In the exemplary embodiment, the pulley bracket 11 has a bent plate structure with a flanged-U-shaped cross-section.

In the exemplary embodiment, the bracket locking unit 13 includes a locking part 15 which closely mounts the pulley bracket 11 to the door, and a support holding part 17 which integrally extends from the locking part 15 and by which the removable support member 9 is removably held.

In other words, the bracket locking unit 13 has the function of holding the removable support member 9 so as to control the positional relationship between the removable support member 9, the upper pulley 5 and the lower pulley 7, in addition to the function of mounting the pulley bracket 11 to the door.

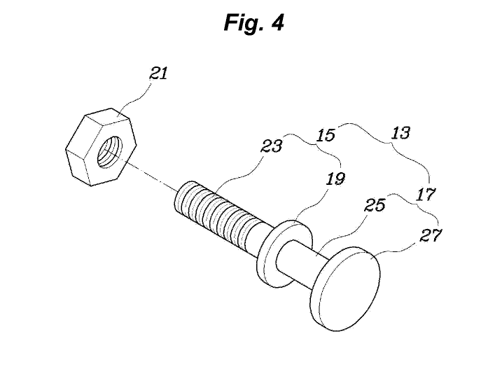

As shown in FIG. 4, the locking part 15 according to the exemplary embodiment includes a pressure flange 19, which biases the pulley bracket 11 to the surface of the door under pressure, and a threaded part 23, which extends from the pressure flange 19 and passes through the door prior to being tightened to a locking nut 21. The support holding part 17 includes a support rod 25 extending from the pressure flange 19 and a guide flange 27 formed on an outside end of the support rod 25.

Here, the guide flange 27 prevents the removable support member 9 from being undesirably removed from the support rod 25 in an axial direction in a state in which the removable support member 9 is held by the support rod 25. Therefore, due to the guide flange 27, the removable support member 9 can be maintained in a state in which the removable support member 9 is stably held by the support rod 25.

The removable support member 9 is constructed in such a way that the removable support member 9 can normally control the relative position of the upper pulley 5 and the lower pulley 7 and can be removed from both the upper pulley 5 and the lower pulley 7 in response to the pressure that causes the removable support member 9 to be displaced relative to the pulley locking unit 10.

To achieve the above-mentioned function, the removable support member 9 includes an elastic support part 29. When pressure is applied to the elastic support part 29, which has elastically biased the support rod 25 of the pulley locking unit 10 under pressure and causes displacement of the elastic support part 29 relative to the pulley locking unit 10, the elastic support part 29 becomes deformed and removed from the support rod 25.

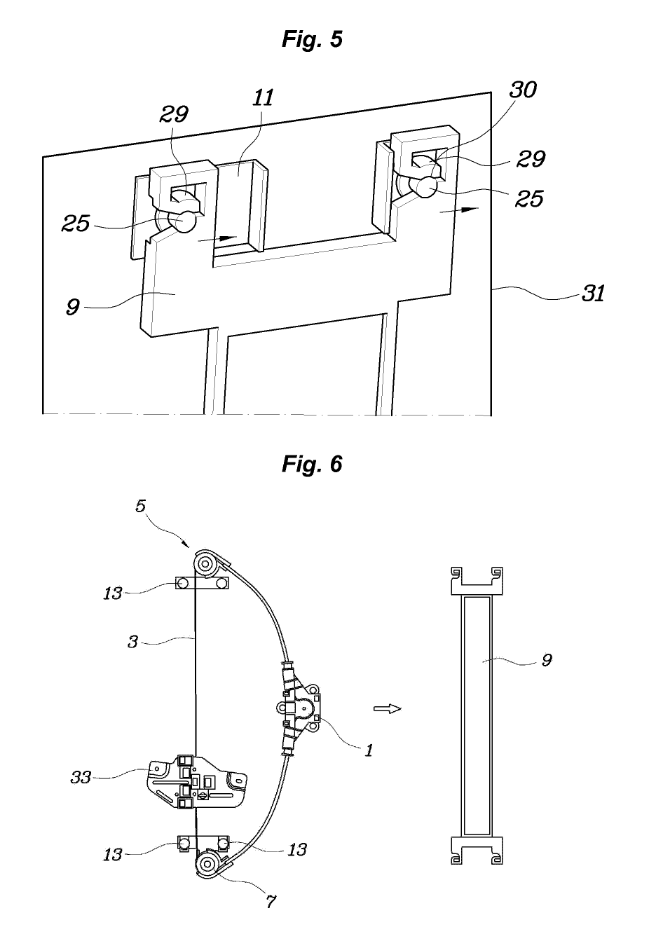

In the exemplary embodiment of the present invention, as shown in FIG. 5, the elastic support part 29 is formed by bending an end of the removable support member 9 inwards to open in one direction such that the elastic support part 29 can elastically compress the support rod 25 inside the removable support member 9.

In an exemplary embodiment of the present invention, an end of elastic support part 29 may include an arc-shaped locking groove 30 such that the removable support member 9 can be further firmly engaged to the support rod 25.

The removable support member 9 includes a plurality of elastic support parts 29 which have the same orientation in such a way that the elastic support parts 29 can be deformed by pressure capable of moving the removable support member 9 in opposite direction relative to an engaging direction of the pulley locking unit 10, thus causing the removable support member 9 to be removed from the elastic support parts 29.

Therefore, when the removable support member 9 is pushed in opposite direction relative to an engaging direction of the pulley locking unit 10, that is, the rightward direction in FIG. 5, after the upper pulley 5 and the lower pulley 7 have been mounted to the door using respective bracket locking units 13, the removable support member 9 is removed from the support holding part 17 of the bracket locking unit 13 and realizes a removable state.

The window regulator of the vehicle according to an exemplary embodiment of the present invention is fed to a door assembly line in a state in which the removable support members 9 are assembled in the window regulator as shown in FIG. 2 so as to realize improved feeding and assembling efficiency.

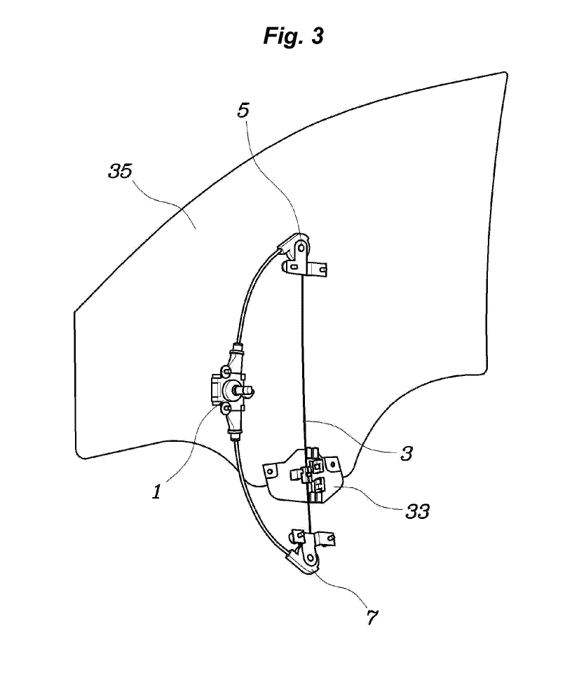

In a door assembling process, the pulley bracket 11 is mounted to the door using the bracket locking unit 13. In other words, as shown in FIG. 3, the threaded part 23 of the bracket locking unit 13 is tightened to the locking nut 21 after sequentially passing through the pulley bracket 11 and a door inner panel 31, thus firmly mounting the pulley bracket 11 to the door by the compression force formed between the locking nut 21 and the pressure flange 19.

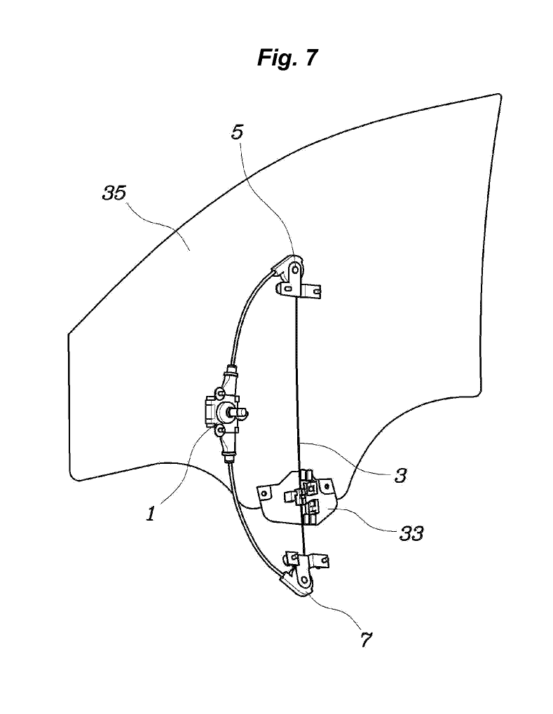

In the state in which the pulley bracket 11 is mounted to the door, the locations of the upper pulley 5 and the lower pulley 7 are fixed so that even when the removable support members 9 is removed, the fixed locations of the upper pulley 5 and the lower pulley 7 on the door can remain stable. Therefore, when the removable support member 9 in the above state is pushed so as to remove the elastic support parts 29 from respective support rods 25, the removable support member 9 can be completely removed from the window regulator and realizes the state shown in FIG. 7.

The removable support member 9 removed from the pulley locking unit 10 is reused in a subsequent process of assembling another window regulator.

In the same manner as that of a conventional window regulator, a carrier plate 33 carrying a window pane 35 is mounted to the wire 3 which is guided by the upper pulley 5 and the lower pulley 7. When the carrier plate 33 is moved upwards and downwards along with the wire 3 actuated by the actuator 1, the window pane 35 is moved in the same direction and, in the above state, movement of the window pane 35 is guided by door channels formed in the door at opposite sides of the window pane 35.

In other words, the upward and downward movement of the window pane 35 is realized by a force provided by both the wire 3 and the carrier plate 33 while being guided by the opposite door channels.

As described above, the window regulator of the vehicle according to an exemplary embodiment of is constructed in such a way that the support 9 can be removed from the window regulator after assembling the regulator and can be reused in a subsequent process of assembling another window regulator. Therefore, the present invention can reduce the weight of a vehicle and can reduce the production cost of the window regulator.

For convenience in explanation and accurate definition in the appended claims, the terms “upper”, “lower”, “inner” and “outer” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms included, and obviously many modifications and variations is possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A window regulator assembly of a vehicle, including:
an actuator;
a wire connected to the actuator and actuated by the actuator;
an upper pulley and a lower pulley provided in upper and lower positions of a door for guiding movement of the wire;
a pulley locking unit provided for mounting the upper pulley and the lower pulley to the door; and
a removable support member, wherein the removable support member controls a relative position of the upper pulley and the lower pulley therebetween and is removed from the upper pulley and the lower pulley after the upper pulley and the lower pulley is installed on the door.

2. The window regulator assembly of the vehicle as set forth in claim 1, wherein the pulley locking unit includes:
a pulley bracket provided for rotatably supporting a rotating shaft of the upper and lower pulleys respectively thereto; and
a bracket locking unit provided for mounting the pulley bracket to the door,
wherein the removable support member is coupled to the bracket locking unit and released therefrom after the upper pulley and the lower pulley is installed on the door.

3. The window regulator assembly of the vehicle as set forth in claim 2, wherein the bracket locking unit includes:
a locking part mounting the pulley bracket to the door; and
a support holding part integrally extending from the locking part and removably holding the removable support member thereto.

4. The window regulator assembly of the vehicle as set forth in claim 3,
wherein the locking part includes:
a pressure flange biasing the pulley bracket to the door under pressure; and
a threaded part extending from the pressure flange and passing through a door inner panel of the door, and being tightened to a locking nut; and
wherein the support holding part includes:
a support rod extending from the pressure flange to which the removable support member is removably engaged; and
a guide flange formed on an end of the support rod to retain the removable support member between the pressure flange and the guide flange.

5. The window regulator assembly of the vehicle as set forth in claim 2, wherein the removable support member is constructed in such a way that the removable support member controls the relative position of the upper pulley and the lower pulley and after construction thereof to the bracket locking unit is removed from the bracket locking unit in response to a pressure causing a displacement of the removable support member relative to the pulley locking unit.

6. The window regulator assembly of the vehicle as set forth in claim 5, wherein the removable support member includes:
an elastic support part formed to open in one direction to receive a support rod of the bracket locking unit, wherein the elastic support part is deformed and released from the support rod in response to a pressure, which is applied to the elastic support part in an opposite direction of the one direction.

7. The window regulator assembly of the vehicle as set forth in claim 6, wherein an end of the elastic support part includes an arc-shaped locking groove to receive the support rod therein.

8. The window regulator assembly of the vehicle as set forth in claim 6, wherein the elastic support part of the removable support member includes:
a plurality of elastic support parts which have the same orientation in such a way that the elastic support parts is deformed by pressure so as to move the removable support member in the opposite direction of the one direction and thus to release the removable support member from the support rod.

9. The window regulator assembly of the vehicle as set forth in claim 6, wherein the elastic support part of the removable support member is formed by bending an end of the removable support member inwards to open in the one direction such that the elastic support part elastically compresses the support rod of the pulley locking unit inside the removable support member.

10. A method of a window regulator assembly of a vehicle, including:
installing a pulley bracket having an upper pulley and a lower pulley on a door by using a removable support member wherein the removable support member temporarily controls a relative position of the upper pulley and the lower pulley; and
removing the removable support member from the door after construction of the pulley bracket.
